(19) United States
(12) Patent Application Publication
(10) Pub. No.: US 2005/0283470 A1
(43) Pub. Date: Dec. 22, 2005

(54) Content categorization

(76) Inventors: Or Kuntzman, Kfar-Saba (IL); Tamir Chen, Tel-Aviv (IL); Nir Zisso, Kfar-Saba (IL)

Correspondence Address: DANIEL J SWIRSKY, 55 REUVEN ST., BEIT SHEMESH, 99544, IL

(21) Appl. No.: 10/869,042

(22) Filed: Jun. 17, 2004

(51) Int. Cl. G06F 17/30

(52) U.S. Cl. 707/4

(57) ABSTRACT

A method for content categorization including firstly retrieving content from a first content source from among a categorized list of content sources, extracting a plurality of words from the firstly retrieved content, associating any of the words with a category to which the firstly retrieved content is associated in the categorized list, secondly retrieving content from a second content source independently from the categorized list of content sources, extracting a plurality of words from the secondly retrieved content, and associating the secondly retrieved content with the category where any of the words in the secondly retrieved content matches any of the words in the firstly retrieved content, where the match is in accordance with a predefined heuristic.

### FIELD OF THE INVENTION

The present invention relates to the categorization of content in general, and more particularly to the categorization of computer network-based content.

### BACKGROUND OF THE INVENTION

The Internet's vast array of web sites and enormous pools of information have the capability of overwhelming a typical web surfer. While each web site may attempt to cater its services to a specific clientele, a web surfer interested in a particular set of services might not know in advance which web site will provide the services he is interested in. Search engines, such as yahoo™, provide one mechanism to enable web surfers to limit and focus their browsing to a subset of websites. The information available on the web is organized and typically categorized by the search engines and stored on the search engine's web server.

Unfortunately, this reliance on search engines limits a web surfer's choices to web sites monitored by the search engine and requires the web surfer to accept the search engine's categorization of web sites. Web sites that are not known to a search engine or not categorized in a way that the web surfer expects may never be found.

Categorization of web pages is a multi-faceted science. Content-based search engines, such as Google™, extract keywords from web pages and enable searches of these keywords. Category-based search engines, such as Yahoo™, organizes web sites into categories, often after much manual manipulation by search engine managers.

The content currently displayed by the browser is perhaps the best indication of what a web surfer is searching for. While search engines provide a context for the content, web surfers that directly access a service provider's web site have no contextual information. A web surfer may like what he sees but is unable to find similar web sites.

### SUMMARY OF THE INVENTION

The present invention discloses a system and method for categorizing computer network-based content, such as web pages.

In one aspect of the present invention a method is provided for content categorization, the method including firstly retrieving content from a first content source from among a categorized list of content sources, extracting a plurality of words from the firstly retrieved content, associating any of the words with a category to which the firstly retrieved content is associated in the categorized list, secondly retrieving content from a second content source independently from the categorized list of content sources, extracting a plurality of words from the secondly retrieved content, and associating the secondly retrieved content with the category where any of the words in the secondly retrieved content matches any of the words in the firstly retrieved content, where the match is in accordance with a predefined heuristic.

In another aspect of the present invention the method further includes constructing an occurrence table relating each of a plurality of structures of the firstly retrieved content with any unique occurrences of any of the words in the firstly retrieved content which appear within the structure and a number of the occurrences thereof.

In another aspect of the present invention the method further includes removing predefined ones of the words in the firstly retrieved content from the occurrence table.

In another aspect of the present invention the method further includes removing predefined common articles of language.

In another aspect of the present invention the first associating step includes constructing a word relationship table from the associations of the words in the firstly retrieved content and the category.

In another aspect of the present invention the method further includes maintaining the association with the category as part of a hierarchy of a plurality of categories.

In another aspect of the present invention any of the steps are performed by a server.

In another aspect of the present invention any of the steps are performed by a client.

In another aspect of the present invention a method is provided for content categorization, the method including retrieving content from a content source, extracting a plurality of words from the retrieved content, and associating the retrieved content with a category where any of the words in the retrieved content matches any word in a group of words previously associated with the category, where the match is in accordance with a predefined heuristic.

In another aspect of the present invention the method further includes presenting information relating to the category via a user interface. In another aspect of the present invention the method further includes presenting the category via within a window on a display of a computer which retrieved the content.

In another aspect of the present invention the method further includes presenting a parent category of the category via within a window on a display of a computer which retrieved the content.

In another aspect of the present invention either of the extracting and associating steps includes applying the heuristic to a first portion of the content, and thereafter applying the heuristic to a second portion of the content where no category match is found for the first portion.

In another aspect of the present invention the associating step includes associating the retrieved content with a plurality of categories, and selecting one of the categories having the most letters.

In another aspect of the present invention the associating step includes associating the retrieved content with a plurality of categories, and selecting one of the categories having the greatest descriptive measure in accordance with a predefined measure per category.

In another aspect of the present invention the method further includes querying a second content source using one or more words associated with either of the category and the retrieved content, receiving from the second content source in response to the query one or more links to content, presenting any of the links for selection by a user, and providing access to content indicated by any of the links upon selection of the link.

In another aspect of the present invention any of the steps are performed by a client.

In another aspect of the present invention any of the steps are performed by a client.

In another aspect of the present invention a method is provided for server-side categorization of content, the method including receiving at a server a request from a client for content from the server, extracting a plurality of words from the retrieved content, associating the retrieved content with a category where any of the words in the retrieved content matches any word in a group of words previously associated with the category, where the match is in accordance with a predefined heuristic, and modifying the content in accordance with a predefined modification associated with the category.

In another aspect of the present invention the modifying step includes inserting into the content an advertisement associated with the category.

In another aspect of the present invention the method further includes selecting one category from among a plurality of the categories associated with the requested content in accordance with a function of the expected value of the categories.

In another aspect of the present invention the selecting step includes selecting the category for which the click-thru rate for advertisements associated with the category is greatest.

In another aspect of the present invention the method further includes selecting one category from among a plurality of the categories associated with the requested content in accordance with a predefined selection preference order of the categories.

In another aspect of the present invention the method further includes selecting one category from among a plurality of the categories associated with the requested content in accordance with a combined selection heruristic based on a function of the expected value of the categories and a predefined selection preference order of the categories.

In another aspect of the present invention a system is provided for content categorization, the system including means for firstly retrieving content from a first content source from among a categorized list of content sources, means for extracting a plurality of words from the firstly retrieved content, means for associating any of the words with a category to which the firstly retrieved content is associated in the categorized list, means for secondly retrieving content from a second content source independently from the categorized list of content sources, means for extracting a plurality of words from the secondly retrieved content, and means for associating the secondly retrieved content with the category where any of the words in the secondly retrieved content matches any of the words in the firstly retrieved content, where the match is in accordance with a predefined heuristic.

In another aspect of the present invention the system further includes an occurrence table relating each of a plurality of structures of the firstly retrieved content with any unique occurrences of any of the words in the firstly retrieved content which appear within the structure and a number of the occurrences thereof.

In another aspect of the present invention the system further includes means for removing predefined ones of the words in the firstly retrieved content from the occurrence table.

In another aspect of the present invention the system further includes means for removing predefined common articles of language.

In another aspect of the present invention the system further includes a word relationship table including the associations of the words in the firstly retrieved content and the category.

In another aspect of the present invention the system further includes where the association with the category is part of a hierarchy of a plurality of categories.

In another aspect of the present invention any of the means are embodied in a server.

In another aspect of the present invention any of the means are embodied in a client.

In another aspect of the present invention a system is provided for content categorization, the system including means for retrieving content from a content source, means for extracting a plurality of words from the retrieved content, and means for associating the retrieved content with a category where any of the words in the retrieved content matches any word in a group of words previously associated with the category, where the match is in accordance with a predefined heuristic.

In another aspect of the present invention the system further includes means for presenting information relating to the category via a user interface. In another aspect of the present invention the system further includes means for presenting the category via within a window on a display of a computer which retrieved the content.

In another aspect of the present invention the system further includes means for presenting a parent category of the category via within a window on a display of a computer which retrieved the content.

In another aspect of the present invention either of the extracting and associating means are operative to apply the heuristic to a first portion of the content, and thereafter apply the heuristic to a second portion of the content where no category match is found for the first portion.

In another aspect of the present invention the means for associating is operative to associate the retrieved content with a plurality of categories, and select one of the categories having the most letters.

In another aspect of the present invention the means for associating is operative to associate the retrieved content with a plurality of categories, and select one of the categories having the greatest descriptive measure in accordance with a predefined measure per category.

In another aspect of the present invention the system further includes means for querying a second content source using one or more words associated with either of the category and the retrieved content, means for receiving from the second content source in response to the query one or more links to content, means for presenting any of the links for selection by a user, and means for providing access to content indicated by any of the links upon selection of the link.

In another aspect of the present invention any of the means are embodied in a client.

In another aspect of the present invention any of the means are embodied in a client.

In another aspect of the present invention a system is provided for server-side categorization of content, the system including means for receiving at a server a request from a client for content from the server, means for extracting a plurality of words from the retrieved content, means for associating the retrieved content with a category where any of the words in the retrieved content matches any word in a group of words previously associated with the category, where the match is in accordance with a predefined heuristic, and means for modifying the content in accordance with a predefined modification associated with the category.

In another aspect of the present invention the means for modifying step is operative to insert into the content an advertisement associated with the category.

In another aspect of the present invention the system further includes means for selecting one category from among a plurality of the categories associated with the requested content in accordance with a function of the expected value of the categories.

In another aspect of the present invention the means for selecting is operative to select the category for which the click-thru rate for advertisements associated with the category is greatest.

In another aspect of the present invention the system further includes means for selecting one category from among a plurality of the categories associated with the requested content in accordance with a predefined selection preference order of the categories.

In another aspect of the present invention the system further includes means for selecting one category from among a plurality of the categories associated with the requested content in accordance with a combined selection heruristic based on a function of the expected value of the categories and a predefined selection preference order of the categories.

### BRIEF DESCRIPTION OF THE DRAWINGS

The present invention will be understood and appreciated more fully from the following detailed description taken in conjunction with the appended drawings in which:

FIG. 1A is a simplified pictorial illustration of a categorization system, constructed and operative in accordance with a preferred embodiment of the present invention;

FIG. 1B is a simplified flow chart illustration of a method for data acquisition and classification, operative in accordance with a preferred embodiment of the present invention;

FIG. 1C is simplified pictorial illustration of an exemplary occurrence table, constructed and operative in accordance with a preferred embodiment of the present invention;

FIG. 1D is simplified pictorial illustration of an exemplary word relationship table, constructed and operative in accordance with a preferred embodiment of the present invention;

FIG. 2A is a simplified pictorial illustration of a client categorizer system, constructed and operative in accordance with a preferred embodiment of the present invention;

FIG. 2B is a simplified flow chart illustration of a method for extraction and categorization of browser content, operative in accordance with a preferred embodiment of the present invention;

FIG. 2C is a simplified pictorial illustration of a browser display with a button bar assistant, constructed and operative in accordance with a preferred embodiment of the present invention;

FIG. 2D is a simplified flow chart illustration of a method for assisting a user, operative in accordance with a preferred embodiment of the present invention; and

FIG. 3 is a simplified flow chart illustration of a method for server-side extraction and categorization of content, operative in accordance with a preferred embodiment of the present invention.

### DETAILED DESCRIPTION OF PREFERRED EMBODIMENTS

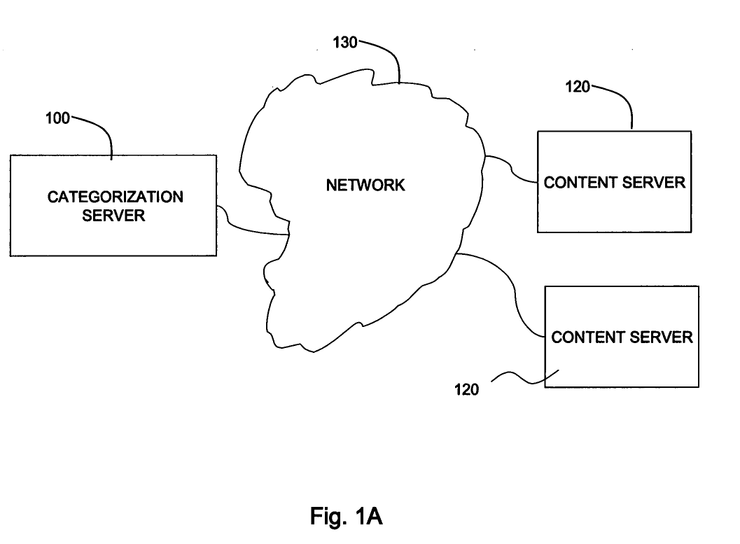

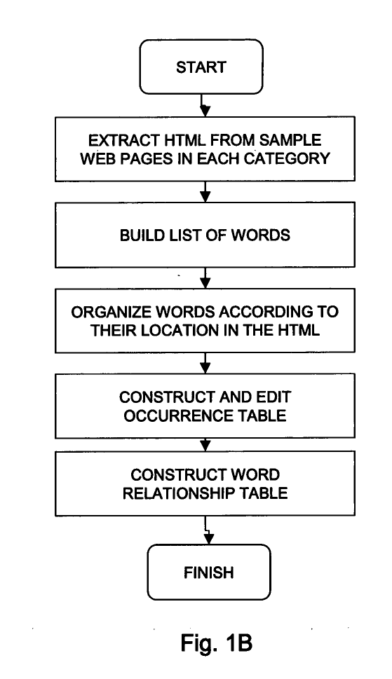

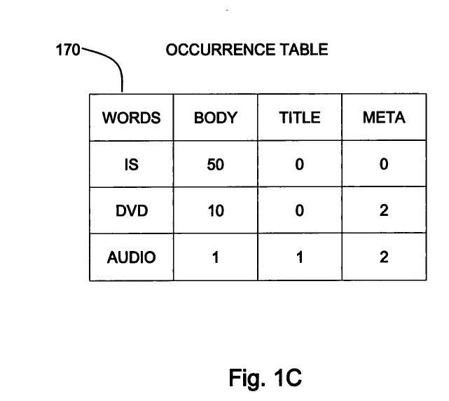

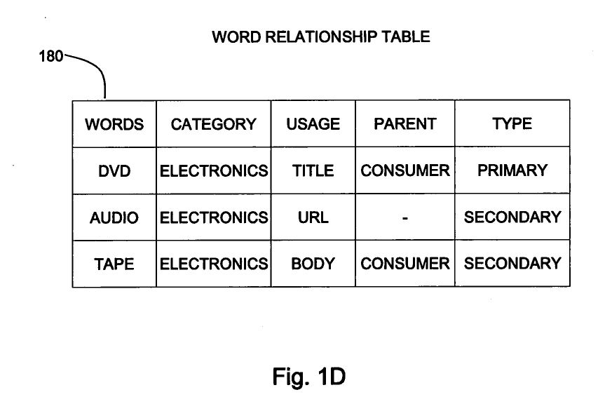

Reference is now made to FIG. 1A, which is a simplified pictorial illustration of a categorization system, constructed and operative in accordance with a preferred embodiment of the present invention, FIG. 1B, which is a simplified flow chart illustration of a method for data acquisition and classification, operative in accordance with a preferred embodiment of the present invention, FIG. 1C, which is simplified pictorial illustration of an example occurrence table, constructed and operative in accordance with a preferred embodiment of the present invention, and FIG. 1D, which is simplified pictorial illustration of an example word relationship table, constructed and operative in accordance with a preferred embodiment of the present invention. A categorization server 100 preferably retrieves content from a content server 120 connected to a network 130, such as the Internet. Categorization server 100 typically ‘trawls’ through a categorized list of content sources, such as web sites, on content servers 120 to retrieve content, typically in the form of HTML or XML documents, although any type of textual or graphical document may be analyzed. Lists of content sources are typically categorized by search engines, such as Yahoo™, into one or more categories, such as “Electronics” and “Education,” and include a relatively large number of content servers 120 per category, such as from two hundred and fifty to over a thousand.

Categorization server 100 preferably extracts the words from the retrieved content and constructs an occurrence table 170, shown in FIG. 1C, as follows. The columns of occurrence table 170 are preferably associated with the structure of the content, such as for HTML content, where each column may correspond to an HTML tag, and where the rows of occurrence table 170 correspond to unique words that appear in the content. Each cell of occurrence table 170 may be filled with the number of occurrences of the word. For example, occurrence table 170 is constructed from an HTML document in which the word ‘DVD’ appears ten times in the segment of content within the body tag, i.e. between the open tag <body> and the close tag </body> of the HTML document, and not at all in the segment of content within the title tag.

Categorization server 100 preferably edits occurrence table 170 to remove spurious information, such as common articles of language, e.g. ‘is’, and constructs a word relationship table, such as is shown in table A below, associating words in occurrence table 170 with their respective category, such as the category under which the retrieved content is categorized as indicated by one or more of the categorized lists provided by one or more search engines. Once a word has been associated with a category, it may be used to indicate that other content, even content that has not been categorized by a search engine, may belong to the same category. For example, as per table A, an HTML document whose URL includes the word ‘DVD’, such as in ‘www.dvdguys.com’, may be considered to belong to the category ‘electronics’ based on the existing association between the word ‘DVD’ and the category ‘electronics’.

TABLE A
Table A provides an example of the
form that a word relationship may take:

| | | | | | | | | Secon- |
|---|---|---|---|---|---|---|---|---|
| | | | | | | C | Primary | dary |
| | | Cate- | Elec- | E | A1 | 3 | DVD | audio |
| | | gory: | tronics | | | | | |
| Based | 239 | Results: | 98% | E | A1 | 4 | CD | tape |
| On: | | | | | | | | |
| A1?: | Y | E?: | N | | A1 | 5 | batteries | |
| | | | | | | 0 | TV | |
| | | | | | | 5 | power | |
| | | | | | | 0 | amplifier | |

Elements of Table A are defined as follows:
‘Category’: the name of the category, e.g., ‘Electronics’;
‘Based On’: how many documents where retrieved from content servers 120 to create this category, e.g., 239;
‘Results’: the recognition percentage, i.e. how many documents from those retrieved to create the category, were recognized as belonging to the category, e.g., 98%;
A1: is the word or category found in x % the titles, where x is predefined;
E: the word or category typically found in y/o of the URLs, where y is predefined;
C: the number of appearances of the word or category found at the URL (0 or greater)
Primary: Words in this column are primary words, i.e. words that, alone or in combination with each other, indicate a particular category to the exclusion of other categories, e.g., where ‘DVD’ is an indicator of the category ‘Electronics’ and no other category;
Secondary: Words in this column are secondary words, i.e. words that are relevant to a particular category, but not to the exclusion of other categories.
   Values for any of the elements of table A may be determined using any known statistical technique or predefined heuristic. For example, in order to determine whether a word is a primary or secondary word of the category, if the word appears in 95% of the documents retrieved to create the definition and does not appear in more than 20% of all other documents retrieved to create all other definitions, the word may be classified as a primary word, while all other words that appear in more than 20% of the documents may be considered secondary even though they appear in other categories as well. Moreover, further information related to the relationships between words, not shown in the above table, may be incorporated into a word relationship table and may include hierarchal information, such as the context of a category, where ‘Electronics’ is a sub-category of ‘Consumer’ goods. A simplified version of a word relationship table showing hierarchal information is shown in table 180 of FIG. 1D.

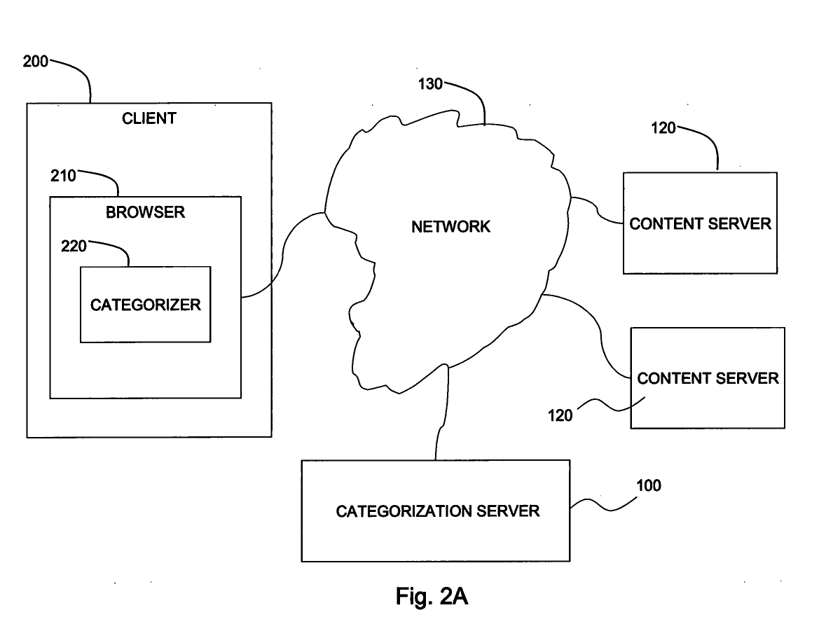

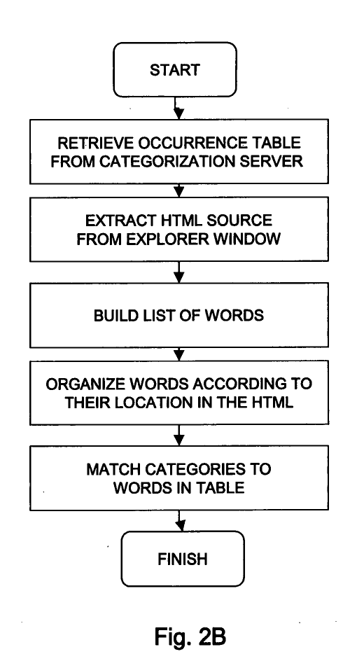

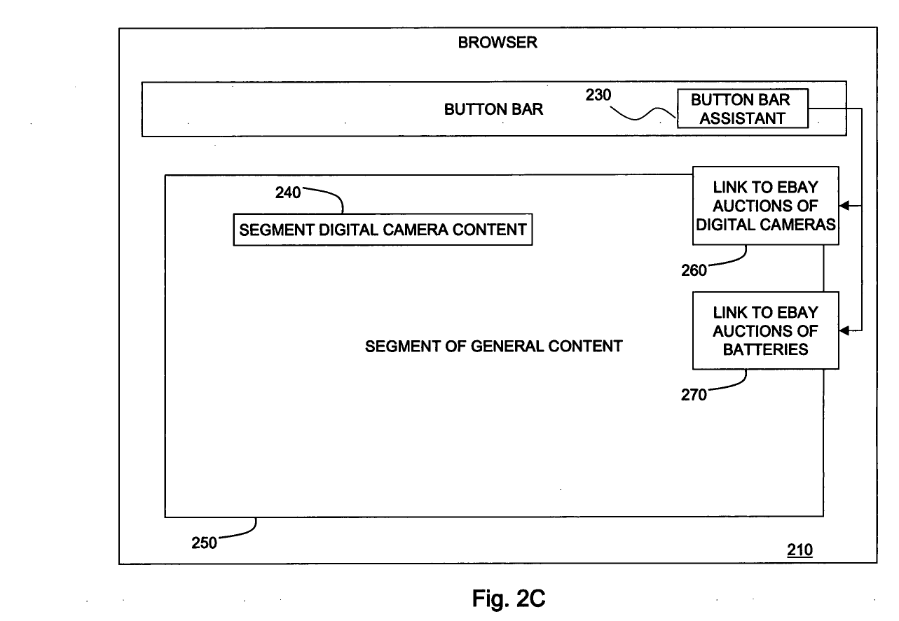

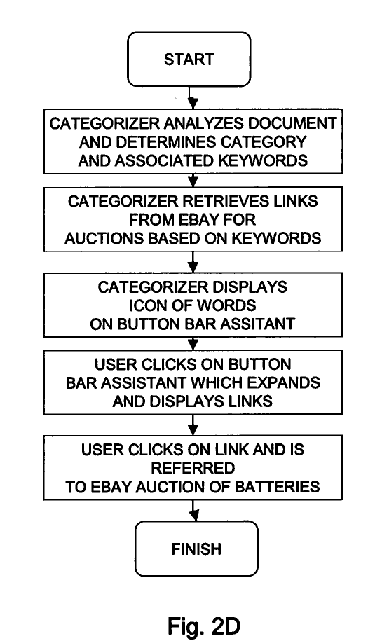

Reference is now made to FIG. 2A, which is a simplified pictorial illustration of a client categorizer system, constructed and operative in accordance with a preferred embodiment of the present invention, FIG. 2B, which is a simplified flow chart illustration of a method for extraction and categorization of browser content, operative in accordance with a preferred embodiment of the present invention, FIG. 2C, which is a simplified pictorial illustration of a browser display with a button bar assistant, constructed and operative in accordance with a preferred embodiment of the present invention, and to FIG. 2D, which is a simplified flow chart illustration of a method for assisting a user, operative in accordance with a preferred embodiment of the present invention. A client 200 typically employs a browser 210 to retrieve content from content servers 120 over network 130. Browser 210 preferably includes a categorizer 220 that retrieves word relationship table 180 constructed by categorization server 100. Categorizer 220 is also capable of monitoring the activity of browser 210 and receiving notifications from browser 210. For example, categorizer 220 is preferably notified when browser 210 completes the retrieval of an HTML document, and categorizer 220 preferably extracts from browser 210 the title from the content of the HTML document in browser 210's window as described in the following code snippet:

MSHTML::IHTMLDocument2Ptr doc;
MSHTML::IHTMLElementCollectionPtr col;
MSHTML::IHTMLElementPtr EL;
DWORD 1Res;
HRESULT hres;
CComQIPtr<IPersistStreamInit> spPersist;
HRESULT hr;
CComQIPtr<MSHTML::IHTMLDocument2> spDoc;
UINT MSG = RegisterWindowMessage (“WM_HTML_GETOBJECT”);
SendMessageTimeout(hWnd, MSG, 0, 0, SMTO_ABORTIFHUNG, 1000, &1Res);
hResult =

ObjectFromLresult (1Res,_uuidof(MSHTML::IHTMLDocument2), 0, (void**) &doc);

hres = doc->get_title (&bstrTemp);
spPersist = spDoc;
if (spPersist != NULL)
{

memset (glb_chSource, 0, sizeof (glb_chSource) );
IStream* pStream = NULL;
hr = CreateStreamOnHGlobal (NULL, true, &pStream);
if (FAILED (hr))
{

return hr;

}
hr = spPersist->Save (pStream, true);
if (FAILED (hr))
{

return hr;

}
unsigned long ulSize;
LARGE_INTEGER liPosition;
liPosition.QuadPart = 0;
hr = pStream->Seek (liPosition,STREAM_SEEK_SET,NULL);
if (FAILED (hr))
{

return hr;

}
hr = pStream->Read ((void*) glb_chSource, SOURCE_MAX_SIZE, &ulSize);
if (FAILED (hr))
{

return hr;

}
hr = pStream->Commit (STGC_DEFAULT);
if (FAILED (hr))
{

return hr;

}
pStream->Release ( );

}

Categorizer 220 constructs occurrence table 170 as described hereinabove with reference to FIG. 1C and matches words in the occurrence table 170 constructed for the current document in browser 210 with words in the word relationship table 180 retrieved from categorization server 100 by employing a set of heuristics, with a goal of determining the most likely matching category for the entire occurrence table 170. These heuristics are preferably predefined. For example, the following heuristics may be applied:

The current document is said to belong to a particular category where:

1. The title of the document contains a word that is a primary word of the category as per the word relationship table; or
2. The title of the document contains a secondary word of the category and the body of the document contains two secondary words as well.
   A complete set of the heuristics, known as the “HtCheck category recognition builder”, is commercially available from Idium (ISA) Inc. 530 Fifth avenue, 23^{rd} floor, New York, N.Y., 10036.

Categorizer 220 is preferably implemented to optimize the processing time necessary to match occurrence table 170 with word relationship table 180. For example, categorizer 220 may first apply heuristics to the content title, found early in a web page, and continue to apply heuristics to the body only if the title heuristics are inconclusive, i.e. occurrence table 170 does not match any category in word relationship table 180 following the title heuristics.

Word relationship table 180 may include multiple descriptions of a category. Categorizer 220 preferably extracts from word relationship table 180 the most descriptive words of a category to present to client 200, as described hereinbelow. In one methodology, the length of a word may be utilized to determine the descriptive nature of a word without manual intervention. Categorizer 220 preferably chooses the word with the most letters, i.e. longest word, as the most descriptive word. In an alternate methodology, categorizer 220 may refer to a measure of the descriptive characteristics of each word in the word relationship table 180 that is entered manually.

Categorizer may present information related to the category or categories found to correspond to the current document in browser 210, such as the category name, via a user interface, such as a computer display or speaker. Categorizer 220 preferably employs a button bar assistant 230 as shown in FIG. 2C, such as may be displayed within a window of browser 210, for presenting category information. In addition, categorizer 220 may present to client 200 associated words extracted from word relationship table 180, such as the parent of the most specific category, where, for example, ‘consumer’ is the parent category of ‘electronics’ as indicated by one or more of the categorized lists provided by one or more search engines.

Categorizer 220 may create a set of keywords based on the information and associated words found to correspond to the current document in browser 210 and search external sources, such as commercial web sites, for links to further information that are typically associated with the keywords. For example, the current document in browser 210 as shown in FIG. 2C includes an area of digital camera content 240 embedded within an area of general content 250. In the method of FIG. 2D, categorizer 220 preferably analyzes the document and determines, in accordance with the present invention, that the document is associated with the category ‘digital camera’, which is a child category of ‘electronics’. Furthermore, categorizer 220 determines from word relationship table 180 that the word ‘batteries’ is associated with the category ‘digital camera’. Next, categorizer 220 may query eBay™ with the keywords ‘digital camera’ and ‘batteries’, and retrieve links to current auctions associated with those keywords. An icon or word is preferably displayed in button bar assistant 230 to indicate to the user that links have been retrieved by categorizer 220. When the user clicks on button bar assistant 230, button bar assistant 230 preferably expands to display the links retrieved, being, for example, a link to eBay™auctions of digital cameras 260 and a link to eBay™ auctions of batteries 270. The user may click on a link, such as the link to eBay™ auctions of batteries 270, and be referred to the associated auction site in accordance with conventional techniques.

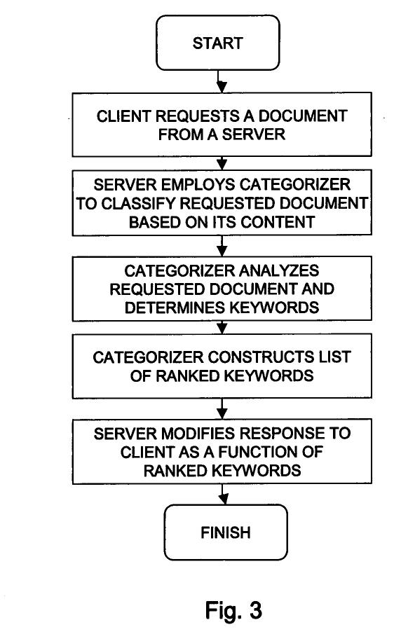

Reference is now made to FIG. 3, which is a simplified flow chart illustration of a method for server-side extraction and categorization of content, operative in accordance with a preferred embodiment of the present invention. In the method of FIG. 3, categorizer 220 may be implemented on content server 120, and may provide categorization information to content server 120 when client 200 requests a specific document from content server 120. Categorizer 220 is preferably employed to analyze the specific document prior to its transmission to client 200 and provide category information associated with the document.

Categorizer 220 may define the single best category for a requested document as a function of the expected value of the category. For example, where client 200 requests a document from amazon.com™ that describes a Nikon™ camera, categorizer 220 may determine that the top three appropriate categories in order of relevance, as defined through heuristics employed to match occurrence table 170, constructed for the document retrieved from amazon.com™, with word relationship table 180, are ‘camera,’ ‘digital camera’ and ‘lens.’ Categorizer 220 may then analyze the value of each category as a function of the click-through rate of the advertisements for each category, where advertising click-thru rates and the associations between advertisements and categories may be provided to categorizer 220 from any source using conventional techniques. If, historically, lens advertisements (i.e., advertisements that are of the ‘lens’ category) are clicked on more often than camera or digital camera advertisements, categorizer 220 may inform content server 120 that the category ‘lens’ is the single best category for the requested document.

Alternatively, a single best category may be selected based on a predefined category selection heuristic. For example, preference may be given to the category appearing in the document title, followed by the category appearing in the document body. Thus, in the above example, if the category ‘camera’ appears in the document title, it may be selected as the single best category for the document if the category ‘digital camera’ appears in the body. This selection method may be combined with selection by expected value described above in accordance with a predefined heuristic. For example, if by the selection preference method ‘camera’ should be selected over ‘digital camera’, a combined selection heuristic might give preference to non-selected category ‘digital camera’ if its click-thru rate is twice that of the selected category ‘camera.’

Once categorizer 220 determines the single or single best category for the requested content, server 120 preferably utilizes the information provided by categorizer 220 to modify the document requested by client 200. For example, the document requested may include a placeholder for an advertisement. Server 120 preferably modifies the document by removing the placeholder and inserting an advertisement for camera lenses from any source of advertisement using conventional techniques.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention. Thus, the present invention need not be limited to the field of advertising, but may be employed in any context where content recognition is required, such as in support of advertising, content control, web crawling, or any other context that may require it's use.

1. A method for content categorization, the method comprising:
firstly retrieving content from a first content source from among a categorized list of content sources;
extracting a plurality of words from said firstly retrieved content;
associating any of said words with a category to which said firstly retrieved content is associated in said categorized list;
secondly retrieving content from a second content source independently from said categorized list of content sources;
extracting a plurality of words from said secondly retrieved content; and
associating said secondly retrieved content with said category where any of said words in said secondly retrieved content matches any of said words in said firstly retrieved content, wherein said match is in accordance with a predefined heuristic.

2. A method according to claim 1 and further comprising constructing an occurrence table relating each of a plurality of structures of said firstly retrieved content with any unique occurrences of any of said words in said firstly retrieved content which appear within said structure and a number of said occurrences thereof.

3. A method according to claim 2 and further comprising removing predefined ones of said words in said firstly retrieved content from said occurrence table.

4. A method according to claim 2 and further comprising removing predefined common articles of language.

5. A method according to claim 1 wherein said first associating step comprises constructing a word relationship table from said associations of said words in said firstly retrieved content and said category.

6. A method according to claim 1 and further comprising maintaining said association with said category as part of a hierarchy of a plurality of categories.

7. A method according to claim 1 wherein any of said steps are performed by a server.

8. A method according to claim 1 wherein any of said steps are performed by a client.

9. A method for content categorization, the method comprising:
retrieving content from a content source;
extracting a plurality of words from said retrieved content; and
associating said retrieved content with a category where any of said words in said retrieved content matches any word in a group of words previously associated with said category, wherein said match is in accordance with a predefined heuristic.

10. A method according to claim 9 and further comprising presenting information relating to said category via a user interface.

11. A method according to claim 9 and further comprising presenting said category via within a window on a display of a computer which retrieved said content.

12. A method according to claim 9 and further comprising presenting a parent category of said category via within a window on a display of a computer which retrieved said content.

13. A method according to claim 9 wherein either of said extracting and associating steps comprises applying said heuristic to a first portion of said content, and thereafter applying said heuristic to a second portion of said content where no category match is found for said first portion.

14. A method according to claim 9 wherein said associating step comprises associating said retrieved content with a plurality of categories, and selecting one of said categories having the most letters.

15. A method according to claim 9 wherein said associating step comprises associating said retrieved content with a plurality of categories, and selecting one of said categories having the greatest descriptive measure in accordance with a predefined measure per category.

16. A method according to claim 9 and further comprising:
querying a second content source using one or more words associated with either of said category and said retrieved content;
receiving from said second content source in response to said query one or more links to content;
presenting any of said links for selection by a user; and
providing access to content indicated by any of said links upon selection of said link.

17. A method according to claim 9 wherein any of said steps are performed by a client.

18. A method according to claim 16 wherein any of said steps are performed by a client.

19. A method for server-side categorization of content, the method comprising:
receiving at a server a request from a client for content from said server;
extracting a plurality of words from said retrieved content;
associating said retrieved content with a category where any of said words in said retrieved content matches any word in a group of words previously associated with said category, wherein said match is in accordance with a predefined heuristic; and
modifying said content in accordance with a predefined modification associated with said category.

20. A method according to claim 19 wherein said modifying step comprises inserting into said content an advertisement associated with said category.

21. A method according to claim 19 and further comprising selecting one category from among a plurality of said categories associated with said requested content in accordance with a function of the expected value of said categories.

22. A method according to claim 21 wherein said selecting step comprises selecting said category for which the click-thru rate for advertisements associated with said category is greatest.

23. A method according to claim 19 and further comprising selecting one category from among a plurality of said categories associated with said requested content in accordance with a predefined selection preference order of said categories.

24. A method according to claim 19 and further comprising selecting one category from among a plurality of said categories associated with said requested content in accordance with a combined selection heruristic based on a function of the expected value of said categories and a predefined selection preference order of said categories.

25. A system for content categorization, the system comprising:
means for firstly retrieving content from a first content source from among a categorized list of content sources;
means for extracting a plurality of words from said firstly retrieved content;
means for associating any of said words with a category to which said firstly retrieved content is associated in said categorized list;
means for secondly retrieving content from a second content source independently from said categorized list of content sources;
means for extracting a plurality of words from said secondly retrieved content; and
means for associating said secondly retrieved content with said category where any of said words in said secondly retrieved content matches any of said words in said firstly retrieved content, wherein said match is in accordance with a predefined heuristic.

26. A system according to claim 25 and further comprising an occurrence table relating each of a plurality of structures of said firstly retrieved content with any unique occurrences of any of said words in said firstly retrieved content which appear within said structure and a number of said occurrences thereof.

27. A system according to claim 26 and further comprising means for removing predefined ones of said words in said firstly retrieved content from said occurrence table.

28. A system according to claim 26 and further comprising means for removing predefined common articles of language.

29. A system according to claim 25 and further comprising a word relationship table including said associations of said words in said firstly retrieved content and said category.

30. A system according to claim 25 and further comprising wherein said association with said category is part of a hierarchy of a plurality of categories.

31. A system according to claim 25 wherein any of said means are embodied in a server.

32. A system according to claim 25 wherein any of said means are embodied in a client.

33. A system for content categorization, the system comprising:
means for retrieving content from a content source;
means for extracting a plurality of words from said retrieved content; and
means for associating said retrieved content with a category where any of said words in said retrieved content matches any word in a group of words previously associated with said category, wherein said match is in accordance with a predefined heuristic.

34. A system according to claim 33 and further comprising means for presenting information relating to said category via a user interface.

35. A system according to claim 33 and further comprising means for presenting said category via within a window on a display of a computer which retrieved said content.

36. A system according to claim 33 and further comprising means for presenting a parent category of said category via within a window on a display of a computer which retrieved said content.

37. A system according to claim 33 wherein either of said extracting and associating means are operative to apply said heuristic to a first portion of said content, and thereafter apply said heuristic to a second portion of said content where no category match is found for said first portion.

38. A system according to claim 33 wherein said means for associating is operative to associate said retrieved content with a plurality of categories, and select one of said categories having the most letters.

39. A system according to claim 33 wherein said means for associating is operative to associate said retrieved content with a plurality of categories, and select one of said categories having the greatest descriptive measure in accordance with a predefined measure per category.

40. A system according to claim 33 and further comprising:
means for querying a second content source using one or more words associated with either of said category and said retrieved content;
means for receiving from said second content source in response to said query one or more links to content;
means for presenting any of said links for selection by a user; and
means for providing access to content indicated by any of said links upon selection of said link.

41. A system according to claim 33 wherein any of said means are embodied in a client.

42. A system according to claim 40 wherein any of said means are embodied in a client.

43. A system for server-side categorization of content, the system comprising:
means for receiving at a server a request from a client for content from said server;
means for extracting a plurality of words from said retrieved content;
means for associating said retrieved content with a category where any of said words in said retrieved content matches any word in a group of words previously associated with said category, wherein said match is in accordance with a predefined heuristic; and
means for modifying said content in accordance with a predefined modification associated with said category.

44. A system according to claim 43 wherein said means for modifying step is operative to insert into said content an advertisement associated with said category.

45. A system according to claim 43 and further comprising means for selecting one category from among a plurality of said categories associated with said requested content in accordance with a function of the expected value of said categories.

46. A system according to claim 45 wherein said means for selecting is operative to select said category for which the click-thru rate for advertisements associated with said category is greatest.

47. A system according to claim 43 and further comprising means for selecting one category from among a plurality of said categories associated with said requested content in accordance with a predefined selection preference order of said categories.

48. A system according to claim 43 and further comprising means for selecting one category from among a plurality of said categories associated with said requested content in accordance with a combined selection heruristic based on a function of the expected value of said categories and a predefined selection preference order of said categories.
